(19) United States
(12) Patent Application Publication
(10) Pub. No.: US 2004/0143581 A1
(43) Pub. Date: Jul. 22, 2004

(54) Cost-based storage of extensible markup language (XML) data

(76) Inventors: Philip L. Bohannon, Piscataway, NJ (US); Juliana Freire Silva, Portland, OR (US); Prasan Roy, Millburn, NJ (US); Jerome Simeon, New York, NY (US)

Correspondence Address: Thomas Stafford, 4173 Rotherham Court, Palm Harbor, FL, 34685, US

(21) Appl. No.: 10/342,551

(22) Filed: Jan. 15, 2003

(51) Int. Cl. G06F 7/00

(52) U.S. Cl. 707/100

(57) ABSTRACT

Extensible Markup Language (XML) data is mapped to be stored in an alternative data base management system (DBMS) by generating a plurality of alternative ones of mappings in response to a supplied XML document and corresponding XML schema; evaluating at least a prescribed attribute of each of the plurality of mappings with respect to an expected workload for the storage system; and selecting one of the alternative mappings based on the prescribed attribute which is the most advantageous for the expected system workload. More specifically, applicants employ a unique process that utilizes a unique notion of physical XML Schemas, i.e., P-Schemas; a P-Schema costing procedure; a set of P-Schema rewritings; and a search strategy to heuristically determine the P-Schema with the least cost. Specifically, the unique notion of physical XML Schemas, extend XML Schemas to contain data statistics; a P-Schema can be easily and uniquely mapped into a storage configuration for the target DBMS. The P-Schema costing procedure estimates the cost of evaluating the query workload on the corresponding unique storage configuration. The set of P-Schema rewritings, when successively applied to a P-Schema, yields a space of alternative P-Schemas. These alternative P-Schemas have the property that any XML document that is valid for the initial P-Schema is also valid for any of these alternative P-Schemas. The search strategy examines this space of alternative P-Schemas to heuristically determine the P-Schema with the least cost. The storage configuration derived from this least cost P-Schema is the desired storage configuration to be used to store the XML data in the target DBMS.

### TECHNICAL FIELD

This application relates to storage of XML data in a database management system. The concepts described herein can be applied, more particularly, to storing XML data in relational database management systems.

### BACKGROUND OF THE INVENTION

The Extensible Markup Language (XML) has become an important medium for representing, exchanging and accessing data over the Internet. As applications are processing an increasing amount of XML data, there is a growing interest in storing XML data in database management systems (DBMS) so that these applications can use a complete set of data management services and benefit from the highly optimized query processors. These services include concurrency control, crash recover, scalability and the like.

However, storing XML data in most commercial database management systems (e.g. Oracle, IBM DB2, Microsoft SQL Server, Versant) is not straightforward because of the mismatch between XML's data model, which is tree-structured, and the data models (relational, object-oriented) used in these systems. To address this mismatch, and hence enable the applications to store XML data in these commercial database systems, a number of heuristic mapping strategies have been proposed. These mapping techniques generate a Schema for the underlying database system and define how the given XML data is to be stored in the database system based on this Schema. However, these mapping strategies do not take application characteristics into account, and the generated mapping is therefore unlikely to work well for all of the possible access patterns different applications may present. For example, a Web site may perform a large volume of simple lookup queries, whereas a catalog printing application may require large and complex queries with deeply nested results.

On the other hand, recent versions of commercial DBMSs allow the developers to specify their own Schemas for the purpose of storing XML. Although this approach may be more flexible in some applications, it requires development effort, and the mastering of two complex technologies, namely, XML and the DBMS product used. Moreover, it might be extremely difficult, even for an expert, to determine a good mapping for a complex application.

### SUMMARY OF THE INVENTION

These and other problems and limitations of prior known arrangements, and an advancement in the art is made, for mapping Extensible Markup Language (XML) data to be stored in a DBMS by generating a plurality of alternative ones of mappings in response to a supplied XML document and corresponding XML schema; evaluating at least a prescribed attribute of each of the plurality of mappings with respect to an expected workload for the storage system; and selecting one of the alternative mappings based on the prescribed attribute which is the most advantageous for the expected system workload.

More specifically, applicants employ a unique process that utilizes a unique notion of physical XML Schemas, i.e., P-Schemas; a P-Schema efficiency, e.g., a costing procedure; a set of P-Schema rewritings, i.e., alternative P-Schemas; and a search strategy to heuristically determine the most efficient P-Schema.

Specifically, the unique notion of physical XML Schemas, i.e., P-Schemas, extend XML Schemas to contain data statistics; a P-Schema can be easily and uniquely mapped into a storage configuration (a database Schema and associated data statistics) for the target DBMS.

The determination of the most efficient P-Schema, in one embodiment, employs a costing procedure that estimates the cost of evaluating the query workload (translated from XQuery into the query language of the target DBMS based on the database Schema) on the corresponding unique storage configuration.

The set of P-Schema rewritings, when successively applied to a P-Schema, yields a space of alternative P-Schemas. These alternative P-Schemas have the property that any XML document that is valid for the initial P-Schema is also valid for any of these alternative P-Schemas.

The search strategy explores this space of alternative P-Schemas to heuristically determine the P-Schema with the most efficiency, e.g., the least cost P-Schema.

The storage configuration derived from this most efficient P-Schema is the desired storage configuration to be used to store the XML data in the target DBMS.

### BRIEF DESCRIPTION OF THE DRAWINGS

FIG. 1 illustrates, in simplified block diagram form, details of the XML mapping process architecture, including an embodiment of the invention;

FIG. 2 shows an XML data sample for a subset of an example Internet Movie Database;

FIG. 3A shows a Document Type Definition (DTD) for a subset of the example Internet Movie Database (IMDB) useful in describing the invention;

FIG. 3B shows an XML Schema description of the IMDB data written in the type syntax of the XML Query Algebra and also useful in describing the invention;

FIG. 4A illustrates an original XML Schema, useful in describing the invention;

FIG. 4B illustrates a mapped Relational Schema from the original XML Schema of FIG. 4A;

FIG. 5A shows an initial XML Schema, useful in describing the invention;

FIG. 5B shows a P-Schema configuration corresponding to the initial XML Schema of FIG. 5A;

FIG. 5C shows a relational configuration corresponding to the initial XML Schema of FIG. 5A and to the P-Schema of FIG. 5B;

FIG. 6 shows a number of queries also useful in describing the invention;

FIG. 7A shows an initial XML Schema;

FIG. 7B shows a P-Schema transformation from the initial Schema of FIG. 7A;

FIG. 7C illustrates a relational configuration mapped from the P-Schema of FIG. 7B;

FIG. 8 illustrates stratified physical types; and

FIG. 9 illustrates a process for finding an efficient P-Schema configuration on a cost basis.

### DETAILED DESCRIPTION

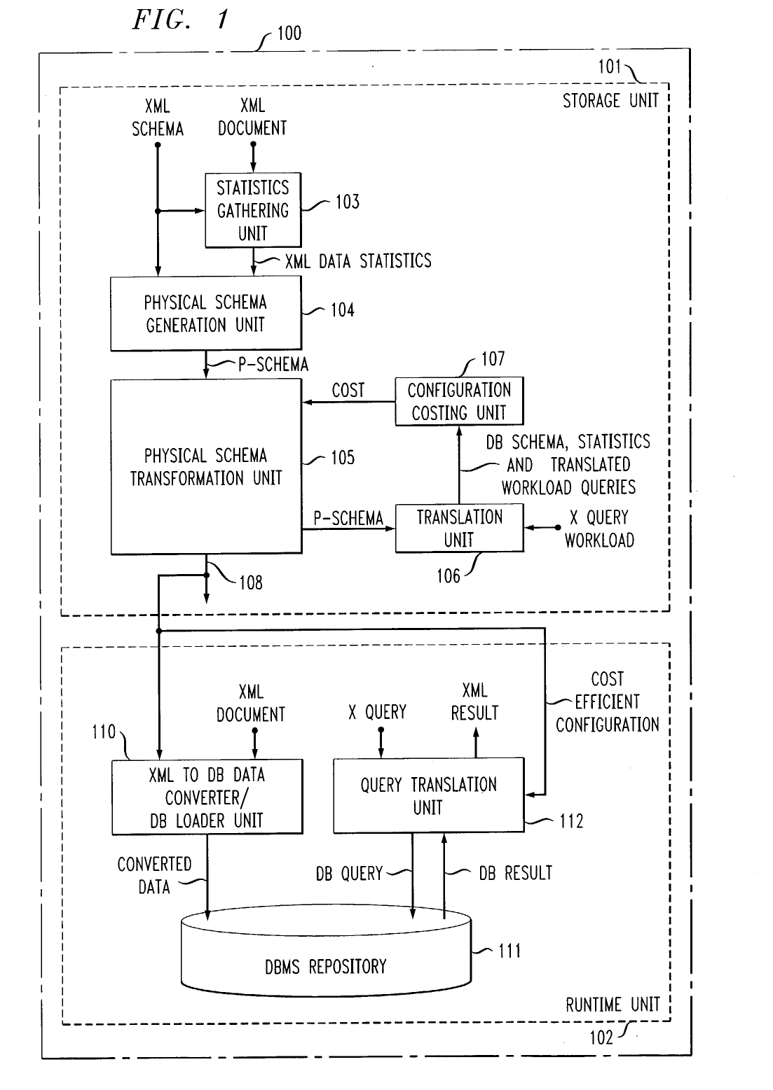

FIG. 1 illustrates, in simplified block diagram form showing details of the XML storage mapping process architecture, including an embodiment of the invention.

The use of the XML Schema and the cost-based evaluation of storage mappings are employed in an example of applicants' unique inventive XML storage mapping scenario having its basis in the Internet Movie Database. See for example, “Internet Movie Database” at http://www.imdb.com.

Consequently, before we delve into the details of applicants' unique architecture shown in FIG. 1, it is felt best to discuss some introductory information regarding XML, the Internet Movie Database, and the mapping of XML to a desired alternative database management system, for example, a relational database management system.

XML Documents and DTDs

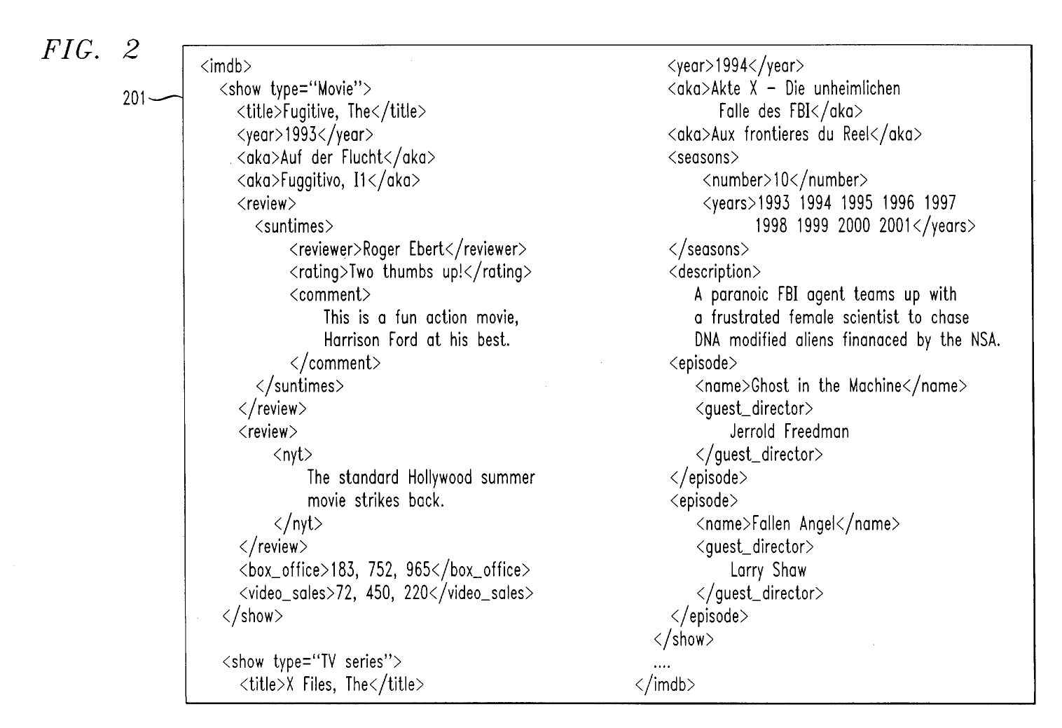

FIG. 2 Illustrates an example XML fragment 201 in which the “show” element is used to represent movies and TV shows. This element contains information that is shared between movies and TV shows, such as title and year, as well as, information specific to movies (e.g., box office and video sales) and to TV shows (e.g., seasons). It will be apparent to those skilled in the art that this unique invention may be employed with arrangements other than those related to the show element or relations.

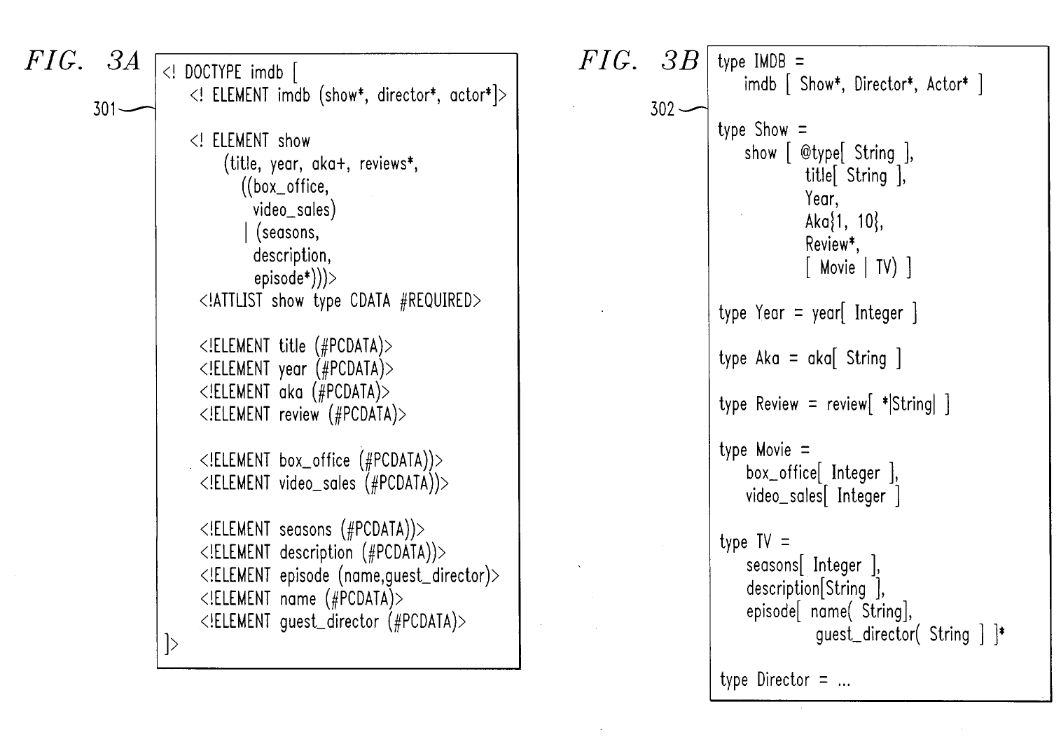

FIG. 3A shows a Document Type Definition (DTD) 301 for the example XML fragment of FIG. 2. The DTD contains declarations for all elements and attributes in the document. The contents of each element may be text (e.g., #PCDATA, CDATA), or a regular expression over other elements (e.g., (show*,director*,actor*)).

Using XML Schema for Storage

FIG. 3B shows an alternative Schema described using the notation for types from the XML Query Algebra. See for example, P. Fankhauser, M. Fernandez, A. Malhotra, M. Rys, J. Sim'eon, and P. Wadler, “The XML query algebra”, February 2001, http://www.w3.org/TR/2001/WD-query-algebra-20010215. Also see the XML Schema and the XML Query Algebra notation shown below.

XML Schema Notation

```
<xsd:schema xmlns=“http://www.w3.org/...”>
<element name=“imdb” type=“IMDB”>
  <complexType name=“IMDB”>
    <element name=“show” type=“Show”
            minOccurs=“0” maxOccurs=“unbounded”/>
    <element name=“director” type=“Director”
            minOccurs=“0” maxOccurs=“unbounded”/>
    <element name=“actor” type=“Actor”
            minOccurs=“0” maxOccurs=“unbounded”/></element>
  </complexType>
<complexType name=“Show”>
  <sequence>
    <element name=“title” type=“xsd:string”/>
    <element name=“year” type=“xsd:integer”/>
    <element name=“aka” type=“Aka”
        maxOccurs=“unbounded”/>
    <element name=“reviews” type=“AnyElement”
            minOccurs=“0” maxOccurs=“unbounded”/>
    <choice>
    <group name=“Movie”/>
    <group name=“TV”/>
    </choice>
  </sequence>
  <attribute name=“type” type=“xsd:string”/>
</complexType>
<complexType name=“Aka”>
    <simpleType name=“xsd:string”/>
</complexType>
<group name=“Movie”>
  <sequence>
    <element name=“box_office” type=“xs:integer”/>
    <element name=“video_sales” type=“xs:integer”/>
  </sequence>
</group>
<group name=“TV”>
  <sequence>
    <element name=“seasons” type=“xs:number” />
    <element name=“description” type=“xs:string” />
    <element name=“episodes”
            minOccurs=“0” maxOccurs=“unbounded”>
    <complexType name=“Episodes”>
      <sequence>
      <element name=“name” type=“xsd:string”/>
      <element name=“guest_director” type=“xsd:string”/>
      </sequence>
    </complexType>
    </element>
  </sequence>
</group>
<complexType name=“Director”>
  <sequence>
    <element name=“name” type=“xsd:string”/>
    <element name=“directed”
            minOccurs=“0” maxOccurs=“unbounded”>
    <complexType name=“Directed”>
      <sequence>
      <element name=“title” type=“xsd:string”/>
      <element name=“year” type=“xsd:integer”/>
      <element name=“info” type=“xsd:string”/>
      <element name=“AnyElement”/>
      </sequence>
    </complexType>
    </element>
  </sequence>
</complexType>
<complexType name=“Actor”>
  <sequence>
    <element name=“name” type=“xsd:string”/>
    <element name=“played”
            minOccurs=“0” maxOccurs=“unbounded”>
    <complexType name=“Played”>
      <sequence>
      <element name=“title” type=“xsd:string”/>
      <element name=“year” type=“xsd:integer”/>
      <element name=“character” type=“xsd:string”/>
      <element name=“order_of_appearance” type=“xsd:string”/>
      <element name=“award”
            minOccurs=“0” maxOccurs=“5”>
        <complexType name=“Played”>
        <sequence>
          <element name=“result” type=“xsd:string”/>
          <element name=“award_name” type=“xsd:string”/>
        </sequence>
        </complexType>
      </element>
      </sequence>
    </complexType>
    </element>
  </sequence>
  </complexType>
</xsd:schema>
```

XML Algebra Notation

```
type IMDB =
  imdb [ Show{0,*},Director{0,*},Actor{0,*} ]
type Show =
  show [ title [ String ], year[ Integer ], type[ String ],
      aka [ String ]{0,*},reviews[ TILDE[ String ] ]{0,*},
      (box_office [ Integer ], video_sales [ Integer ]
      | seasons[ Integer ], description [ String ],
      episodes [ name[String], guest_director[ String ]]{0,*}
      )
    ]
type Director =
  director [ name [String],
        directed [ title[ String ], year[ Integer ],
            info[ String ], TILDE [ String ] ]{0,*}
            ]
type Actor =
  actor [ name [String],
        played[ title[ String ], year[ Integer ],
            character[String], order_of_appearance[Integer],
            award[ result [String], award_name[String] ]{0,5}
              ] {0,*}
        biography[ birthday[ String ], text[String] ]
        ]
```

This notation captures the core semantics of the XML Schema, abstracting away some of the complex features of XML Schema, which are not relevant for the present invention (e.g., the distinction between groups and complex Types, local vs. global declarations, etc.). The XML Schema describes elements (e.g., show) and attributes (e.g., @type) and uses regular expressions to describe allowed sub-elements (e.g., imdb contains Show*, Director*, Actor*). But 302 of FIG. 3B also illustrates a number of distinguishing features, i.e., “types”, that are useful for storage. First, one can specify precise data types (e.g., String, Integer) instead of text, an essential feature for generating an efficient storage configuration. Also, regular expressions are extended with more precise cardinality annotations for collections (e.g., {1, 10} indicates that there can be between 1 to 10 aka elements for show), which enables the specification of more constrained collections. Finally, XML Schema can describe so-called wildcards: for example, the ^{˜}[AnyType] notation specifies that the review element can contain an element with an arbitrary name and content. This allows the XML Schema to describe parts of the Schema for which no precise structural information is available.

Storage Mappings

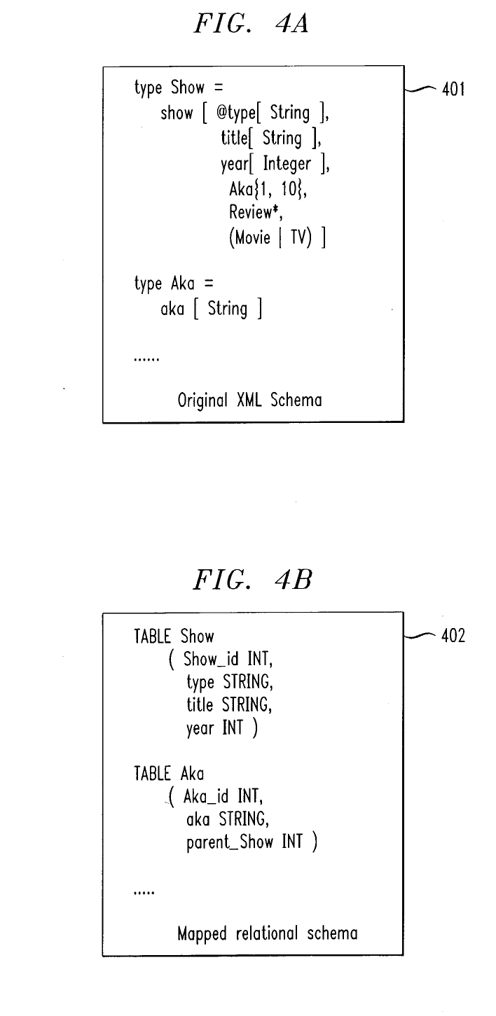

In addition to the features described above, a very important characteristic of the XML Schema is that it distinguishes between elements (e.g., a show element) and their type (e.g., the Show type). The type name never appears in the document, and one element may have different allowed content when it appears in different types. A key feature of the “LegoDB” approach is that it uses the classification of elements to type names as the basis for creating storage mappings. As an example, FIG. 4B shows a sample mapping 402 for a fragment of the original Schema 401 in FIGS. 4A and 3B to a relational Schema configuration. Each type (e.g., Show) can be used to group a set of elements together. The LegoDB mapping engine creates a table for each such type (e.g., Show) and maps the contents of the elements (e.g., type, title, etc.) to columns of that table. Finally, the mapping also generates a key column that contains the “id” of the corresponding element (e.g., Aka_id column), and a foreign key that keeps track of the parent-child relationship (e.g., parent_Show column). Clearly, it is not always possible to map types into relations. For instance, since there can be many episode elements in the type TV, these elements cannot be mapped into columns of that table.

Schema Transformations

An important observation is that there are many different XML Schemas that validate the exact same set of documents. For instance, different but equivalent regular expressions (e.g., (a(b|c*))((a,b)|(a,c*))) can describe the contents of a given element. In addition, the allowed sub-elements of an element can be referred to directly (e.g., the element title in Show), or can be referred to by a type name (e.g., see the type Year). Although the presence of a type name does not change the semantics of the XML Schema, it affects the derived relational Schema, as our mapping generates one relation for each type. Hence, by performing a sequence of transformations (also called rewritings), which preserve the semantics of the Schema and then generating the implied storage mapping, a space of storage mappings can be explored.

Cost-Based Evaluation of XML Storage

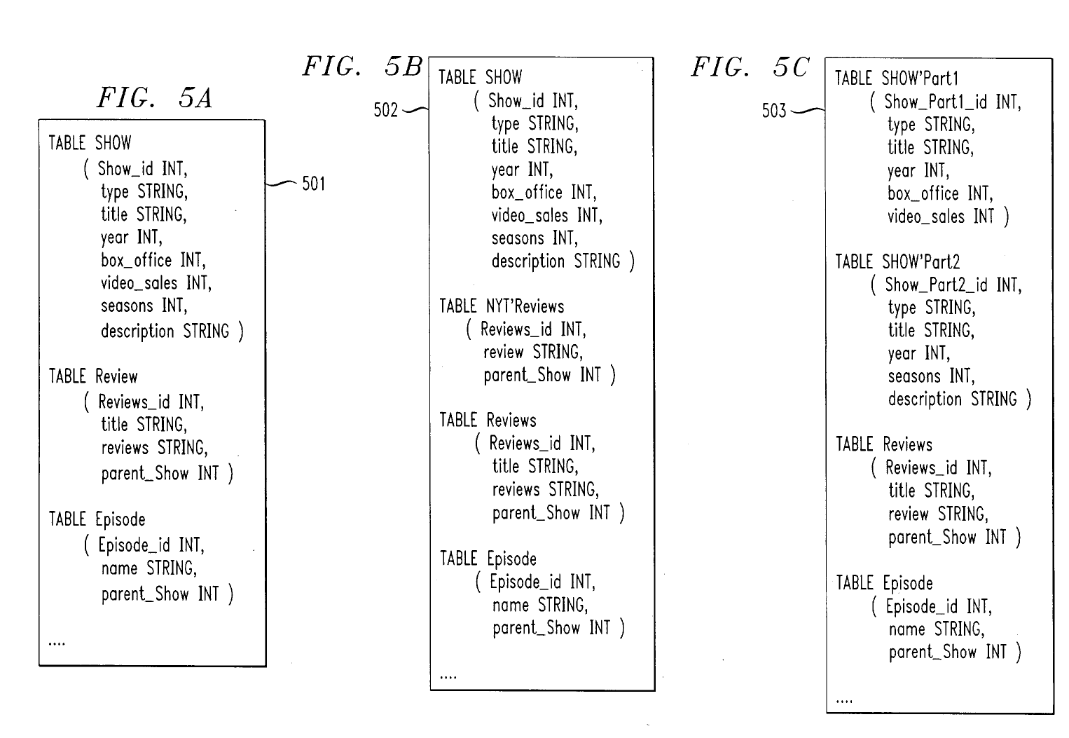

FIGS. 5A, 5B and 5C shows three possible relational storage mappings that are generated by some of the transformations. For instance, configuration 501 of FIG. 5A results from “inlining” as many elements as possible in a given table, roughly corresponding to the strategy advocated in configuration 502 of FIG. 5B is obtained from configuration 501 by partitioning the reviews table into two tables (one that contains New York Times reviews, and another for reviews from other sources). Finally, configuration 503 of FIG. 5C is obtained from configuration 501 by splitting the Show table into Movies or TV shows.

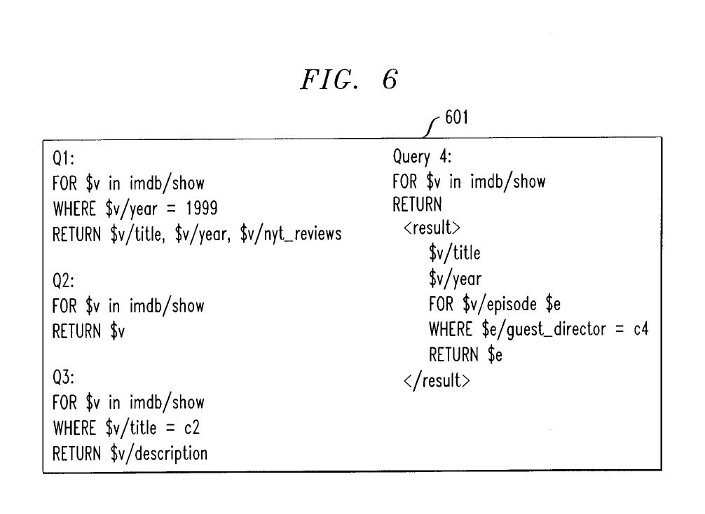

Even though each of these configurations can be the best for a given application, there may be instances where they perform poorly. An important question is then how to select a particular configuration. In LegoDB, this decision is based on query workloads and data statistics. Consider the queries 601 of FIG. 6 described in Xquery. See for example, D. Chambelin, J. Clark, D. Florescu, Jonathan Robie, J. Sim'eon, and M. Stefanescu, “XQuery 1.0: An XML query language”, W3C Working Draft, June 2001.

First query Q1 returns the title, year and the New York Times reviews for all shows from 1999. Q2 publishes all the information available for all shows in the database. Q3 retrieves the description of a show based on the title, and Q4 retrieves episodes of shows directed by a particular guest director. Whereas Q1 and Q2 are typical of a publishing scenario (i.e., to send a movie catalog to an interested partner), Q3 and Q4 contain specific selection criteria and are typical of interactive lookup queries. Applicants then define two workloads, W1 and W2, where W1={Q1: 0.4, Q2: 0.4, Q3: 0.1, Q4: 0.1}, and W2={Q1: 0.1, Q2: 0.1, Q3: 0.4, Q4: 0.4}, where each workload contains a set of queries and an associated weight that could reflect the relative importance of each query for the application. From an application perspective, workload W1 might be representative of the workload generated by a cable company which routinely publishes large parts of the database for download to intelligent set-top boxes, while W2 may represent the lookup queries issued to a movie-information web site, like the IMDB itself.

Table I shows the estimated costs for the queries and workloads returned by the LegoDB storage mapping tool for each configuration in FIGS. 5A-5C. These costs are normalized by the costs of Storage Map 1.

TABLE I

| | Storage Map 1 | Storage Map 2 | Storage Map 3 |
|---|---|---|---|
| | | | FIG. 5C |
| Q1 | 1.00 | 0.83 | 1.27 |
| Q2 | 1.00 | 0.50 | 0.48 |
| Q3 | 1.00 | 1.00 | 0.17 |
| Q4 | 1.00 | 1.19 | 0.40 |
| W1 | 1.00 | 0.75 | 0.75 |
| W2 | 1.00 | 1.01 | 0.40 |

It is important to note that only the first one (501, FIG. 5A) of the three storage mappings shown in FIGS. 5A-5C can be generated by previously known heuristic approaches. However, the resulting mapping has significant disadvantages for either workload applicants consider. First, due to its treatment of union, it inlines several fields, which are not present in all the data, making the Show relation wider than necessary. Second, when the entire Show relation is exported as a single document, the records corresponding to movies need not be joined with the Episode tables, but this join is required by mappings FIG. 5A and FIG. 5B. Finally, the large Description element need not be inlined unless it is frequently queried.

From XML Schema to Relations

As indicated above, the architecture of the LegoDB mapping engine is depicted in FIG. 1, in accordance with the invention. Although this section is entitled XML Schema to Relations, it is to be understood that the architecture can be applied to other DBMSs. Thus, shown are mapping engine 100 including storage unit 101 and runtime unit 102. In storage unit 101, given an XML Schema and statistics extracted from an example XML document, i.e., a data set, via statistics gathering unit 103, physical Schema generation unit 104 generates an initial physical Schema (PS0). An important feature of P-Schemas is that there exists a fixed mapping between P-Schema types and relational tables.

A set of statistics is shown as follows:

Statistics
([“imdb”], STcnt(1));
([“imdb”;“director”], STcnt(26251));
([“imdb”;“director”;“name”], STsize(40));
([“imdb”;“director”;“directed”], STcnt(105004));
([“imdb”;“director”;“directed”; “title”], STsize(40));
([“imdb”;“director”;“directed”;“year”], STbase(1800,2100,300));
([“imdb”;“director”; “directed”;“info”], STcnt(50000));
([“imdb”;“director”; “directed”;“info”], STsize(100));
([“imdb”;“director”;“directed”;“TILDE”], STsize(255));
([“imdb”;“show”], STcnt(34798));
([“imdb”;“show”;“title”], STsize(50));
([“imdb”;“show”;“year”], STbase(1800,2100,300));
([“imdb”;“show”;“aka”], STcnt(13641));
([“imdb”;“show”;“aka”], STsize(40));
([“imdb”;“show”;“type”], STsize(8));
([“imdb”;“show”;“reviews” ], STcnt(11250));
([“imdb”;“show”;“reviews”;“TILDE”], STsize(800));
([“imdb”;“show”;“box_office”], STcnt(7000));
([“imdb”;“show”;“box_office”], STbase(10000,100000000,7000));
([“imdb”;“show”;“video_sales”], STcnt(7000));
([“imdb”;“show”;“video_sales”], STbase(10000,100000000,7000));
([“imdb”;“show”;“seasons”], STcnt(3500));
([“imdb”;“show”;“description”], STsize(120));
([“imdb”;“show”;“episodes”], STcnt(31250));
([“imdb”;“show”;“episodes”;“name”], STsize(40));
([“imdb”;“show”;“episodes”;“guest_director”], STsize(40));
([“imdb”;“actor”], STcnt(165786));
([“imdb”;“actor”;“name”], STsize(40));
([“imdb”;“actor”;“played”], STcnt(663144));
([“imdb”;“actor”;“played”; “title”], STsize(40));
([“imdb”;“actor”;“played”;“year”], STbase(1800,2100,200));
([“imdb”;“actor”; “played” ; “character”], STsize(40));
([“imdb”;“actor”;“played”;“order_of_appearance”], STbase(1,300,300));
([“imdb”;“actor”; “played” ; “award”;“result”], STsize(3));
([“imdb”;“actor”; “played” ; “award”;“award_name”], STsize(40));
([“imdb”;“actor”; “biography” ; “birthday”], STsize(10));
([“imdb”;“actor”; “biography” ; “text”], STcnt(20000));
([“imdb”;“actor”; “biography” ; “text”], STsize(30)).

Details regarding statistics extraction in LegoDB are described in an article authored by J. Freire, J. Haritsa, M. Ramanath, P. Roy and J. Simeon, entitled “Statix: Making XML count”, in Proceedings of ACM SIGMOD International Conference on Management of Data, 2002.

Physical Schema transformation unit 105 transforms the P-Schema from unit 104 and supplies it to translation unit 106 and to runtime unit 102. Additionally, Physical Schema transformation unit 105 supplies the efficient configuration determined via configuration costing unit 107 via 108 to runtime unit 102 and, therein, to XML to DB data converter/DB Loader unit 110 and Query Translation unit 112. In response to the selected efficient configuration, corresponding tables are created in DBMS Repository 111. The DB loader unit of 110 shreds the input XML document and loads it into the created tables. Once the relational database is created and loaded in this example, Query Translation unit 112 performs a query translation on behalf of the target XML application and yields the desired XML result.

To generate an efficient configuration, P-Schemas are repetitively transformed, i.e., new P-Schemas are generated that are structurally different, but that validate the same documents. Note that in the example, because P-Schema types are mapped into relations, by performing Schema transformations, LegoDB generates a series of distinct relational configurations. The physical Schema and the XQuery workload are then input into the Translation unit 106, which, in this example, generates the corresponding relational catalog, i.e., list, (Schema and statistics) and SQL queries that are input into configuration costing unit 107, i.e., a relational optimizer, for cost estimation. In this example, for each transformed P-Schema, Translation unit 106 generates a set of relational tables, translates the XQuery workload into the SQL equivalent and derives the appropriate statistics for the selected tables. As indicated above, this information is supplied to configuration costing unit 107. Schema transformation operations via translation unit 106 are then repeatedly applied to PS0, and the process of Schema/Query translation and cost estimation is repeated in translation unit 106 and configuration costing unit 107, respectively, for each transformed PS until a “good” configuration is found, in accordance with the invention.

Physical XML Schemas

As indicated above, mapping DTDs to relational configurations is a difficult problem. There are several reasons for that: (1) the presence of regular expressions, nested elements and recursive types results in a mismatch with flat relations; (2) DTDs do not differentiate between elements that correspond to entities (e.g., a person) and elements that correspond to some attribute of that entity (e.g., the name of a person)—hence it is not clear whether one should map an element to a relation or to an attribute of a relation; (3) DTDs define no explicit data types for elements (e.g., integer, date), and as a result all values must be stored as strings which can lead to inefficiencies.

XML Schema differs from DTDs in a number of ways. Notably, because XML Schema distinguishes between type names and element description, a straightforward mapping strategy is to create a relation for each type in XML Schema. In addition, XML Schema provides explicit data types, which lead to more natural (and efficient) storage mappings. However, a number of difficulties remain: (a) the mismatch between the structure of XML Schema types and relations, due to the presence of nested tree regular expressions, and (b) the lack of information about the data to be stored, e.g., cardinality of collections and number of distinct values for an attribute, which is necessary for designing an efficient storage mapping. In order to address these problems, applicants introduce the notion of physical XML Schemas (P-Schemas).

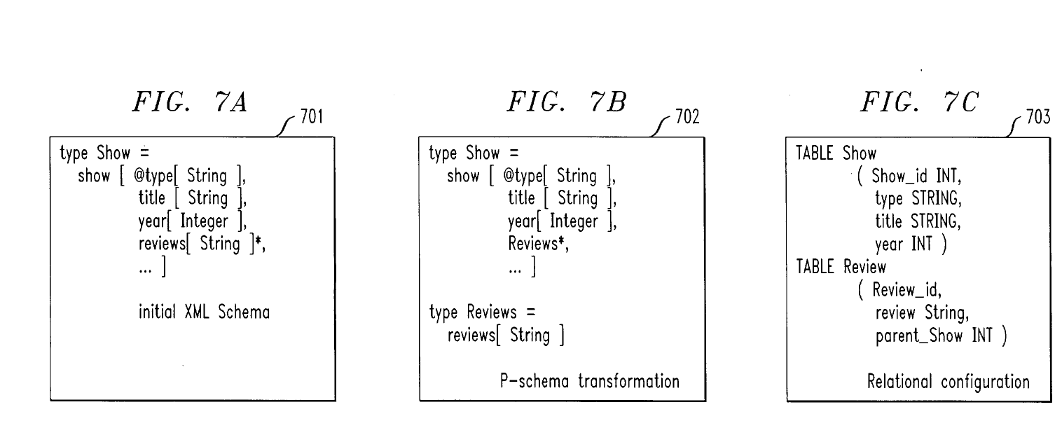

In order to address these problems, applicants introduce, in accordance with the invention, the notion of physical XML Schemas (P-Schemas). P-Schemas have the following properties: (i) they are as expressive as XML Schemas, (ii) they contain useful statistics about the data to be stored, and (iii) there exists a fixed, simple mapping from P-Schemas into relational Schemas. The construction of a P-Schema from an XML Schema is demonstrated through an example, shown in FIGS. 7A-7C. As seen, FIG. 7A is the initial Schema, FIG. 7B is the P-Schema Transform and FIG. 7C is the Relational configuration.

Transforming an XML Schema Into a P-Schema

By inserting appropriate type names for certain elements, one can satisfy (iii) above while preserving the semantics of the original Schema. For instance, in order to guarantee that there exists a simple and unique mapping into a relational configuration, the XML Schema is rewritten so that all multi-valued elements have an associated type name. For example, the Show type of FIG. 7A cannot be stored directly into a relational Schema because there might be multiple review elements in the data. However, the equivalent Schema in FIG. 7B, in which this element is described by a separate type name, can be easily mapped into the relational Schema shown in 7C. The foreign key from the Review table, parent Show is present since the type name Reviews appears within the definition of the Show type.

Data Statistics

The P-Schema also needs to store data statistics. These statistics are extracted from the data and inserted in the original initial physical Schema PS0 during its creation. A sample P-Schema with statistics for the type Show is given below:

```
type Show =
  show [ @type[ String<#8, #2> ],
        year[ Integer<#4, #1800, #2100, #300> ],
        title[ String<#50, #34798> ],
        Review*<#10> ]
type Review =
  review[ String<#800> ]
```

where Scalar <#size, #min, #max, #distincts> indicates for each scalar datatype the corresponding size (e.g., 4 bytes for an integer), minimum and maximum values, and the number of distinct values; and String <#size, #distincts> which specifies the length of a string as well as the number of distinct values. The notation *<#count> indicates the relative number of Review elements within each element of type Show (e.g., in this example, there are 10 reviews per show).

Stratified Physical Types

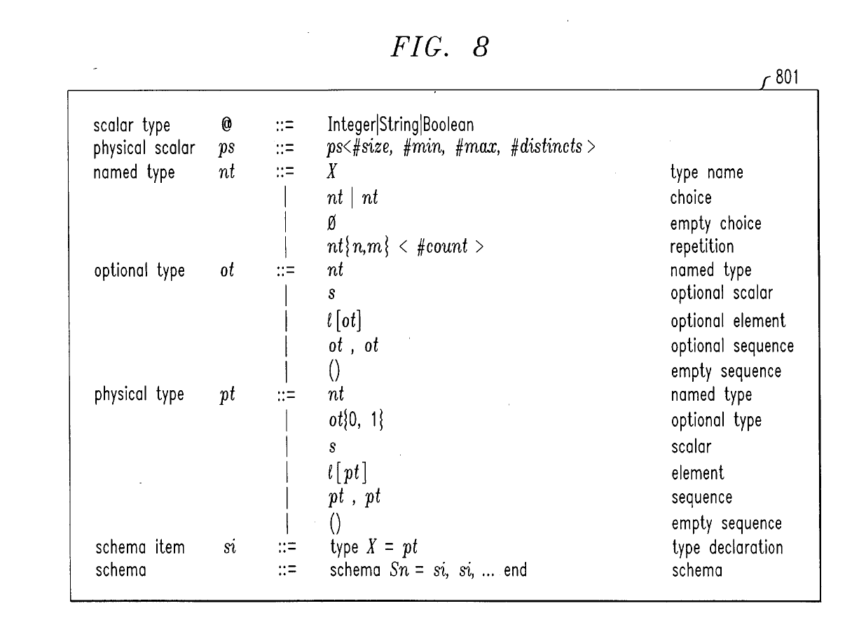

It is now time to define P-Schemas. As discussed, it is essential that each type name contain a structure that can be directly mapped to a relation. Accordingly, applicants adapt the original syntax for types to enforce the appropriate structure. The resulting grammar is shown in FIG. 8. Because this new grammar is stratified (i.e., instead of the types defined in the original XML Schema, there are three different layers of types), it ensures that type names are always used within collections or unions in the Schema. The first layer, physical types, contains only singleton elements, nested singleton elements, and optional types. The second layer, optional types, is used to represent element structures that are tagged with a question mark. Finally, named types can only contain type names and are used to enforce that complex regular expressions (such as union and repetition) do not contain nested elements. An important property of physical Schemas is that any XML Schema has an equivalent physical Schema. As a proof sketch of that statement, one just needs to realize that each Schema can be rewritten by having a type name for each element, and that the resulting Schema is a P-Schema equivalent to the original Schema.

Mapping P-Schemas Into Relations

The reason for the above stratification of physical types is to make sure there is a straightforward mapping from these types into relations. The mapping is as follows:

(a). Create one relation R_{T} for each type name T;

(b). For each relation R_{T}, create a key that will store the node id of the corresponding element;

(c). For each relation R_{T}, create a foreign key To_PT_Key to all relations R_{PT} such that PT is a parent type of T;

(d). A column is created in R_{T} for each sub-element of T that is a physical type;

(e). If the data type is contained within an optional type then the corresponding column can contain a null-value.

Essentially, that mapping procedure follows the stratification of types: elements in the physical types layer are mapped to standard columns, elements within the optional types layer are mapped to columns with null values, and named types are used only to keep track of the child-parent relationship and for the generation of foreign keys.

For an instance “ps” of the P-Schema, the relational Schema defined by the above mapping is referred to as rel(ps). Table II describes these mappings in detail (except computation of foreign keys). For instance: fixed size strings in XML are mapped to fixed sized strings in relational; nested elements are mapped to columns; top level types that contain data types are mapped to a special column that contains a_data column, etc. The μ function is used to map nested elements, the function μ is used to map optional nested elements and the μ₀ function computes the appropriate foreign key for each table. In fact, a similar function is used to propagate statistics from the P-Schema to the relational Schema, but this process is straightforward and omitted for clarity.

TABLE II

| | |
|---|---|
| P-Schema | |
| Schema | Relational |

Datatypes

| | |
|---|---|
| t = String #<size> | μ(t) = CHAR(size) |
| t = String | μ(t) = STRING |
| t = Interger #<size> | μ(t) = INTEGER |
| ... | |
| t = String #<size> | μ(t) = CHAR(size) null |
| t = String | μ(t) = STRING null |
| t = Integer #<size> | μ(t) = INTEGER null |
| ... | |

Elements

| | |
|---|---|
| — | |
| t = a[t′] | μ(t) = <a : a1: psₗ, ... a : an : psₙ>, where |
| μ(t′) = | |
| | <a1: psₗ, ... an : psₙ> |
| t = ˜[t′] | μ(t) = <tilde STRING a : a1: psₗ, ... a : an : |
| | psₙ>, where μ(t′) = <a1 : psₗ, ... an : psₙ> |
| t = t1 , t2 | μ(t) = <a : a1: psₗ, ... an : psₙ, a1′>, where |
| μ(t1) = | |
| | <a1 : psₗ, ... an : psₙ> and μ(t2) = <a1′ : |
| | psₗ, ... am′ : psₙ> |
| t = ot{0,1} | μ(ot) = μₒ (ot) |
| nt | μ(nt) = <> |

Schema

| | |
|---|---|
| type T = String <#count> | TABLE T <T_id INT, _data CHAR(size)> ∘ |
| | <parent(T)> |
| type T = Integer | TABLE T <T_id INT, _data INT> ∘ |
| | <parent(T)> |
| ... | |
| type T = pt | TABLE T <T_id INT> ∘ μ(pt) ∘ |
| | <parent(T)> |

It is noteworthy to mention that, although simple, this mapping deals appropriately with recursive types, and also maps XML Schema wildcards (the ^{˜}elements) appropriately, in accordance with the invention. Take for example, the definition of the AnyElement in the XML Query Algebra:

type AnyElement=^{˜}[(AnyElement|AnyScalar)*]

type AnyScalar=Integer|String

This type is valid for all possible elements with any content. In other words, this is a type for untyped XML documents. Note also that this definition uses both recursive types (AnyElement is used in the content of any element) and a wildcard (^{˜}). Again, applying the above rules, one would construct the following relational Schema:

| | | |
|---|---|---|
| TABLE String | TABLE Integer | TABLE AnyElement = |
| ( _data STRING, | ( _data INT, | ( Element_id INT, |
| parent INT ) | parent INT ) | tilde STRING, |
| | | parent_Element INT) |

This also shows that using XML Schema and the proposed mapping, LegoDB can deal with structured and semistructured documents in a homogeneous way. Indeed, the AnyElement table is similar to the overflow relation used to deal with semistructured document in the STORED system. Also see, A. Deutsch, M. Fernandez, and D. Suciu, Storing semi-structured data with STORED, In Proceedings of SIGMOD, pages 431-442, 1999.

Schema Transformations and Search

Possible transformations for P-Schemas are now described. By repeatedly applying these transformations, LegoDB generates a space of alternative P-Schemas and corresponding relational configurations. As this space can be rather large (possibly infinite), applicants use a greedy search algorithm that our experiments show to be effective in practice.

XML Transformations

Before the P-Schema transformations are defined, it is worth noting that there are important benefits to performing these transformations at the XML Schema level as opposed to transforming relational Schemas. Much of the semantics available in the XML Schema are not present in a given relational Schema and performing the equivalent rewriting at the relational level would imply complex integrity constraints that are not within the scope of relational keys and foreign keys. As an example, consider the rewriting on FIG. 5C: such partitioning of the Show table would be very hard to come up with just considering the original Schema 501. On the other hand, it will be seen that this is a natural rewriting to perform at the XML level. In addition, working at the XML Schema level makes the framework more easily extensible to other non-relational stores such as native XML stores and flat files, where a search space based on relational Schemas would be an obstacle. There is large number of possible rewritings applicable to XML Schemas. Instead of trying to give an exhaustive set of rewriting, focus is on a limited set of such rewritings that correspond to interesting storage alternatives, and that our experiments show to be beneficial in practice.

Inlining/Outlining

As indicated, one can either associate a type name to a given nested element (outlining) or nest its definition directly within its parent element (inlining). Rewriting a XML Schema in that way impacts the relational Schema by inlining or outlining the corresponding element within the corresponding parent table. Inlining is illustrated below using the TV type of FIG. 3B:

| | | |
|---|---|---|
| type TV = | | |
| seasons[ Integer ], | | type TV = |
| Description, | | seasons[ Integer ], |
| Episode* | [symbol] | description[ String ], |
| | | Episode* |
| type Description = | | |
| description[ String ] | | |

At the relational level, this rewriting corresponds to the following transformation:

TABLE TV

| | | |
|---|---|---|
| ( TV_id INT, | | TABLE TV |
| seasons STRING, | | ( TV_id INT, |
| parent_Show INT) | | seasons STRING, |
| | | description STRING |
| | [symbol] | parent_Show INT) |
| TABLE Description | | |
| ( Description_id INT, | | |
| description STRING, | | |
| parent_TV INT) | | |

Two conditions must be satisfied for this transformation to be permissible: the type name must occur in a position where it is not within the production of a named type (i.e., only within sequences or nested elements); and since this rewriting implies that one table is removed from the relational Schema, the corresponding type cannot be shared.

Note that inlining was advocated as one of the main heuristics in the “Relational databases for querying XML documents: Limitations and opportunities” article noted above. Inlining has some similarities with vertical partitioning. It reduces the need for joins when accessing the contents of an element, but it increases the size of the corresponding table. Depending on the significance of accesses to the description element in the query workload, our search algorithm will actually decide whether to outline or inline that element.

Union Factorization/Distribution

Union allows a high-degree of flexibility to XML Schema descriptions. As queries can have different access patterns on unions, e.g., access either parts together or independently, it is essential that appropriate storage structures for unions can be derived. In our framework, applicants use simple distribution laws. The first law ((a,(b|c))==(a,b|a,c)) allows distribution of a union within a regular expression and is illustrated below using the Show type of FIG. 3A:

| | | |
|---|---|---|
| type Show = | | type Show = |
| show [ @type[ String ], | | show [(@type[String ], |
| title[ String ], | | title[ String ], |
| year [ Integer ], | | year [ Integer ], |
| Aka_1,10_, | | Aka {1,10}, |
| Review*, | | Review*, |
| ( Movie \| TV) ] | | box_office[ Integer ], |
| | [symbol] | video_sales[ Integer ]) |
| type Movie = | | \| (@type[ String ], |
| box_office[ Integer ], | | title[ String ], |
| video_sales[ Integer ] | | year [ Integer ], |
| | | Aka {1,10}, |
| | | Review*, |
| type TV = | | seasons[ Integer ], |
| seasons[ Integer ], | | description[ String ], |
| description[ String ], | | Episode*) ] |
| Episode* | | |

Note that the common part of the Schema (title, etc.) is now duplicated, while each part of the union is distributed. The second law (a[t1|t2]==a[t1]|a[t2]) allows to distribute a union across an element and is illustrated on the result of the previous rewriting:

| | | |
|---|---|---|
| | | type Show = |
| | | ( Show'Part1\|Show'Part2 |
| type Show = | | type Show'Part1 = |
| show [(@type[ String ], | | show [ @type[ String ], |
| title[ String ], | | title[ String ], |
| year [ Integer ], | | year [ Integer ], |
| Aka{1,10}, | | Aka{1,10}, |
| Review*, | | Review*, |
| box_office[ Integer ], | | box_office[ Integer ], |
| video_sales[ Integer ]) | | video_sales[ Integer ] ] |
| \|(@type[ String ], | [symbol] | |
| title[ String ], | | type Show'Part2 = |
| year [ Integer ], | | show [ @type[ String ], |
| Aka{1,10}, | | title[ String ], |
| Review*, | | year [ Integer ], |
| seasons[ Integer ], | | Aka{1,10}, |
| description[ String ], | | Review*, |
| Episode*) ] | | seasons[ Integer ], |
| | | description[ String ], |
| | | Episode* ] |

Here the distribution is done across element boundaries. This sequence of rewritings corresponds to the following example relational configurations:

TABLE Show

| | | |
|---|---|---|
| ( Show_id INT, | | TABLE Show_Part1 |
| type STRING, | | ( Show_Part1_id INT, |
| title STRING, | | type STRING, |
| year INT ) | | title STRING, |
| | | year INT, |
| | | box_office INT, |
| | | video_sales INT) |
| TABLE Movie | | |
| ( Movie_id INT, | [symbol] | TABLE Show_Part2 |
| box_office INT, | | ( Show_Part2_id INT, |
| video_sales INT, | | type STRING, |
| parent_Show INT ) | | title STRING, |
| | | year INT, |
| TABLE TV | | seasons INT, |
| ( TV_id INT, | | description STRING) |
| seasons INT, | | |
| description STRING, | | |
| parent_Show INT ) | | |

This results in the Schema shown in FIG. 5C. There are a few important remarks to be made here. First, this rewriting is similar to some form of horizontal partitioning, as Shows with different content will be split in different tables. Still, that partitioning follows the structure of the XML Schema, which might correspond to quite complex criteria on the original relational Schema. Note that the intermediate step in this rewriting is not a valid P-Schema and will not be evaluated for cost before the second half of the transformation is applied. To the best of our knowledge, no previous XML storage approach has considered a similar rewriting.

Repetition Merge/Split

Another useful rewriting exploits the relationship between sequencing and repetition in regular expressions by turning one into the other. The corresponding law over regular expressions (a+==a,a*) is illustrated below on the aka element in the Show type of FIG. 3B:

| | |
|---|---|
| type Show = | |
| show [ @type[ String ], | |
| title [ String ], | [symbol] |
| year[ Integer ], | |
| Aka{1,*} ] | |
| type Show = | |
| show [ @type[ String ], | |
| title [ String ], | [symbol] |
| year[ Integer ], | |
| Aka, Aka{0,*} ] | |
| type Show = | |
| show [ @type[ String ], | |
| title [ String ], | |
| year[ Integer ], | |
| aka [ String ], | |
| Aka{0,*} ] | |

Followed by the appropriate inlining, this transformation captures the following relational configurations:

| | | |
|---|---|---|
| TABLE Show | | TABLE Show |
| ( Show_id INT, | | ( Show_id INT, |
| type STRING, | | type STRING, |
| title STRING, | | title STRING, |
| year INT ) | | year INT, |
| | [symbol] | aka STRING ) |
| TABLE Aka | | TABLE Aka |
| ( Aka_id INT, | | ( Aka_id INT, |
| aka STRING, | | aka STRING, |
| parent_Show INT) | | parent_Show INT) |

Wildcard Rewritings

Wildcards are used to indicate a set of element names that can or cannot be used for a given element. In this example, the notation ‘^{˜}’ is used to indicate that any element name can be used, and the notation ‘^{˜}!a’ is used to indicate that any name but “a” can be used. See for example, W. Fan, G. Kuper, and J. Sim'eon, “A unified constraint model for XML”, In Proceedings of WWW, pages 179-190, Hong Kong, China, May 2001.

In some instances, queries will access specific elements within a wildcard. In that context, it might be interesting to materialize an element name as part of a wildcard as illustrated in the following example:

| | | |
|---|---|---|
| | | type Reviews = |
| type Review = | | review[ ( NYTReview \| OtherReview)* ] |
| review[ ˜[ String ]* ] | [symbol] | |
| | | type NYTReview = nyt[ String ] |
| | | type OtherReview = (˜!nyt) [ String ] |

This transformation can be thought of as distributing of the (implicit) union in the wildcard over the element constructor (i.e.,^{˜}=nyt_reviews|(^{˜}!nyt_reviews)). Here again this results in some form of non-trivial horizontal partitioning over relations. This rewriting is useful if some queries accessNYTimes reviews independently of reviews from other sources.

From Union to Options

All of the previously proposed rewritings preserve exactly the semantics of the original XML Schema. This last rewriting that does not have this nice property, but allows to inline elements of a union using null values. See for example, J. Shanmugasundaram, K. Tufte, G. He, C. Zhang, D. DeWitt, and J. Naughton, “Relational databases for querying XML documents: Limitations and opportunities”, In Proceedings of VLDB, pages 302-314, 1999. This relies on the fact that a union is always contained in a sequence of optional types (i.e., (t1|t2) (t1?, t2?)). This is illustrated below using the Show type of FIG. 3B:

| | | |
|---|---|---|
| type Show = | | |
| show [ @type[ String ], | | |
| title[ String ], | | type Show = |
| year [ Integer ], | | show [ @type[ String ], |
| Aka{1,10} , | | title[ String ], |
| Review*, | | year [ Integer ], |
| (Movie \| TV) ] | | Aka{1,10} , |
| | [symbol] | Review*, |
| type Movie = | | (box_office[ Integer ], |
| box_office [ Integer ], | | video_sales[ Integer ]) ?, |
| video_sales[ Integer ] | | (seasons[ Integer ], |
| | | description[ String ], |
| type TV = | | Episode*) ] |
| seasons[ Integer ], | | |
| description[ String ], | | |
| Episode* | | |

This often results in tables with a large number of null values, but allows the system to inline part of a union, which might improve performances for certain queries.

Search Process

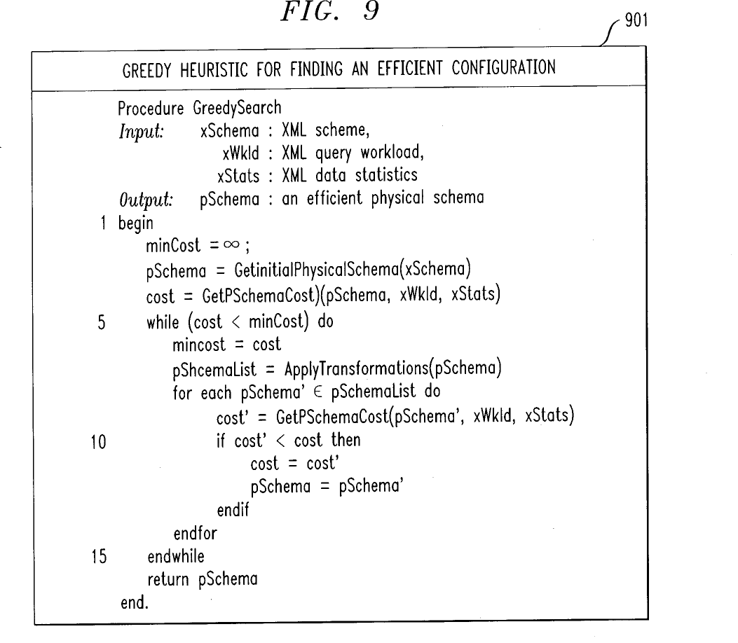

The exploration of the space of storage mappings is described in the process 901 shown in FIG. 9. Note that the set of configurations that result from applying the various Schema transformations is very large (possibly infinite), and since for each configuration, queries and statistics must be translated and sent to the optimizer, i.e., configuration costing unit 107, this process is likely to take an excessive amount of time to complete and may be infeasible in some cases. Instead of exhaustively searching the space of all possible configurations, in this example, a “greedy heuristic” is used to find an efficient configuration.

Inputs to the process are XML Schema, XML query workload, and XML data statistics. Then, the process begins by deriving an initial configuration pSchema from the given XML Schema xSchema (lines 1-3); details of how this initial configuration is derived are described above. Next, the cost of this configuration, with respect to the given query workload xWkld and the data statistics xStats z n is computed using the function GetPSchemaCost, which is described below (line 4). The greedy search (lines 5-16) iteratively updates pSchema to the lowest cost configuration that can be derived from pSchema using a single transformation. Specifically, in each iteration, a list of candidate configurations pSchemaList is created by applying all applicable transformations to the current configuration pSchema (line 7). Each of these candidate configurations is evaluated using GetPSchemaCost and the configuration with the lowest cost is selected (lines 8-14). This process is repeated until the current configuration can no longer be improved and the process is ended (line 17).

Following are details of how GetPSchemaCost computes the cost of a given configuration pSchema given the XML Query workload xWkld and the XML data statistics xStats. First, pSchema is used to derive the corresponding relation. This mapping is also used to translate xStats into the corresponding statistics for the relational data, as well as to translate individual queries in xWkld into the corresponding relational queries in SQL (see below). The resulting relational Schema and the statistics are used by a relational optimizer in configuration costing unit 107 to compute the expected cost of computing a query in the SQL workload derived as above; this cost is returned as the cost of the given pSchema. Note that the algorithm does not put any restriction on the kind of optimizer used (transformational or rule-based, linear or bushy, or the like) though it is expected that it should be the same as (or similar to) the optimizer used in the relational system.

Mapping Queries

Below is a brief outline of the approach used in the instant LegoDB embodiment of the invention to map. For simplicity and clarity of exposition, only a simple but representative subset of Xquery is shown, which contains simple path navigation, selections, joins, nested joins. It will be apparent to those skilled in the art how to evaluate the cost of more complex queries that involve element construction, access to parents, access to order of elements, or nested queries. Note that more sophisticated query mapping techniques can be readily integrated in the LegoDB embodiment by those skilled in the art without departing from applicants' unique invention.

In the LegoDB embodiment of the invention, the mapping of XQuery to SQL is done in two phases. The first phase rewrites an XQuery XQ into a normal form XQ_{nf} which has the following structure:

```
let $doc1 : T1 = ...
let $doc2 : T2 = ...
let $doc3 : T3 = ...
for $v1 in $doc1/a/b,
  $v2 in $v1/c/d,
  $v3 in $doc2/e/f
where $v1 = “s1”
  and $v3 = “s2”
  and $v2 = $v3
return $v1, $v2
```

XQ_{nf} can then be rewritten into an equivalent SQL query on the corresponding Schema in a straightforward manner:

SELECT clause. For each variable v in the return clause of the XQuery, if v refers to a type in the P-Schema, all attributes of the corresponding table are added to the clause. Otherwise, if v refers to an element with no associated type, the corresponding attribute is added to the clause.

FROM clause. For each variable v mentioned in the XQuery, if v refers to a type in the P-Schema, the corresponding table is added to the clause.

Etc.

Note that generating the SQL query based on a given Schema mapping is not trivial, as it requires analysis of the path expression in order to understand the relational tables and columns to be accessed.

Queries

Lookup

```
Q1: Display title, year and type for a show with a given title
FOR $v IN document(“imdbdata”)/imdb/show
WHERE $v/title = c1
RETURN $v/title, $v/year, $v/type
Q2: Display title, year for a show with a given title
FOR $v IN document(“imdbdata”)/imdb/show
WHERE $v/title = c1
RETURN $v/title, $v/year
Q3: Display title, year for all shows in a given year
FOR $v IN document(“imdbdata”)/imdb/show
WHERE $v/year = c1
RETURN $v/title, $v/year
Q4: Display the description, title, year for a show with a given title (only
TV shows have “description”)
FOR $v IN document(“imdbdata”)/imdb/show
WHERE $v/title = c1
RETURN $v/title, $v/year, $v/description
Q5: Display the box office, title, year for a show with a given title (only
movies have “box office”)
FOR $v IN document(“imdbdata”)/imdb/show
WHERE $v/title = c1
RETURN $v/title, $v/year, $v/box_office
Q6: Display the description, box office, title, year for a show with a given
title
FOR $v IN document(“imdbdata”)/imdb/show
WHERE $v/title = c1
RETURN $v/title, $v/year,
        $v/box_office, $v/description
Q7: Display the title and year for shows that have an episode directed
by a given guest director
FOR $v IN document(“imdbdata”)/imdb/show
RETURN
      $v/title,
      $v/year
      FOR $e IN $v/episode
      WHERE $e/guest_director = c1
      RETURN $e/guest_director
Q8: Display the birthday for an actor given his name
FOR $v IN document(“imdbdata”)/imdb/actor
WHERE $v/name = c1
RETURN $v/biography/birthday
Q9: Display the name, biography text for all actors born on a given date
FOR $v IN document(“imdbdata”)/imdb/actor
RETURN
    <result>
      $v/name
      FOR $v/biography $b
      where $b/birthday = c1
      RETURN $b/text
</result>
Q10: Display the name, biography text and birthday for all actors born on
a given date
FOR $v IN document(“imdbdata”)/imdb/actor
RETURN
    <result>
      $v/name
      FOR $v/biography $b
      where $b/birthday = c1
      RETURN $b
</result>
Q11: Display name and order of appearance for all actors that played a
given character
FOR $v IN document(“imdbdata”)/imdb/actor
RETURN
    <result>
      $v/name
      FOR $v/played $p
      where $p/character = c1
      RETURN $p/order_of_appearance
</result>
Q12: Find all people that acted and directed in the same movie
FOR $i IN document(“imdbdata”)/imdb
    $a in $i/actor,
    $m1 in $a/played,
    $d in $i/director,
    $m2 in $a/directed,
WHERE $a/name = $d/name AND $m1/title = $m2/title
RETURN
  <result>
    $a/name
    $m1/title
    $m1/year
</result>
Q13: Find all people that acted and directed in the same movie as well as
alternate titles for the movie
```

| | |
|---|---|
| FOR | $i IN document(“imdbdata”)/imdb |
| | $s in $i/show, |
| | $a in $i/actor, |
| | $m1 in $a/played, |
| | $d in $i/director, |
| | $m2 in $a/directed, |

| | |
|---|---|
| WHERE | $a/name = $d/name AND |
| | $m1/title = $m2/title AND |
| | $m1/title = $s/title |

```
RETURN
  <result>
    $a/name
    $m1/title
    $m1/year
    FOR $v in $s/aka
    RETURN $v/title
</result>
Q14: Find all directors that directed a given actor
```

| | |
|---|---|
| FOR | $i IN document(“imdbdata”)/imdb |
| | $a in $i/actor, |
| | $m1 in $a/played, |
| | $d in $i/director, |
| | $m2 in $a/directed, |

```
WHERE  $a/name = c1 AND $m1/title = $m2/title
RETURN
  <result>
    $d/name
    $m1/title
    $m1/year
</result>
Publish
Q15: Publish all actors
FOR $a IN document(“imdbdata”)/imdb/actor
RETURN $a
Q16: Publish all shows
FOR $s IN document(“imdbdata”)/imdb/show
RETURN $s
Q17: Publish all directors
FOR $d IN document(“imdbdata”)/imdb/director
RETURN $d
Q18: Display all info about a given actor
FOR $a IN document(“imdbdata”)/imdb/actor
WHERE $a/name = c1
RETURN $a
Q19: Display all info about a given show
FOR $s IN document(“imdbdata”)/imdb/show
WHERE $s/title = c1
Q20: Publish all info about a given director
FOR $d IN document(“imdbdata”)/imdb/director
WHERE $d/name = c1
RETURN $d
RETURN $s
```

The foregoing merely illustrates the principles of the invention. It will be appreciated that a person skilled in the art can readily devise numerous other systems, which embody the principles of the invention and, therefore, are within its spirit and scope.

1. A method of mapping extensible markup language (XML) data for storage in an alternative database management system (DBMS) comprising the steps of:
generating a plurality of alternative ones of said mappings in response to a supplied XML document and corresponding XML schema;
evaluating at least a prescribed attribute of each of said plurality of mappings with respect to an expected workload for the storage system; and
selecting one of said alternative mappings based on said prescribed attribute which is the most advantageous for the expected system workload.

2. The method as defined in claim 1 wherein said step of selecting utilizes a greedy heuristic process based on said prescribed attribute to select the most advantageous of said alternative mappings.

3. The method as defined in claim 2 wherein said prescribed attribute for selecting said most advantageous of said alternative mappings is the most efficient one.

4. The method as defined in claim 3 wherein said step of selecting selects the most efficient of said alternative mappings on a cost basis.

5. The method as defined in claim 3 wherein said step of selecting selects the most efficient of said alternative mappings as the one having the least cost.

6. The method as defined in claim 1 wherein the step of selecting includes a) computing the efficiency of an initial mapping configuration with respect to a given query workload and the data statistics using a prescribed function, iteratively updating the mapping configuration to the most efficient configuration that can be derived from said initial mapping using a single transformation, b) evaluating each of the mapping configurations as to its efficiency and c) selecting the most efficient mapping configuration, and d) repeating steps a) through c) until the current mapping configuration can no longer be improved.

7. The method as defined in claim 6 wherein during each iteration of said updating step a list of said alternative mapping configurations is generated by applying all applicable transformations to the current alternative mapping configuration.

8. The method as defined in claim 6 wherein said prescribed function is based on a cost function.

9. A method of mapping extensible markup language (XML) data for storage in an alternative database management system (DBMS) comprising the steps of:
generating an initial physical-schema (P-Schema) from a supplied XML document and a corresponding XML schema;
transforming said initial P-Schema into alternative P-Schemas;
identifying each alternative storage configuration in said alternative DBMS with a unique one of said alternative P-Schemas;
translating each of the alternative P-Schemas into a storage configuration and related statistics for the alternative DBMS;
translating an XML query on the corresponding XML Schema into a query on the alternative DBMS based on the alternative DBMS storage configuration identified to the current alternative P-Schema;
selecting a most efficient alternative P-Schema corresponding to the most efficient alternative storage configuration for said alternative DBMS; and
utilizing said most efficient alternative P-Schema and its corresponding most efficient alternative storage configuration for said alternative DBMS to store XML document data in said alternative DBMS.

10. The method as defined in claim 9 wherein said step of selecting utilizes a greedy heuristic process to select the most efficient of said alternative P-Schemas.

11. The method as defined in claim 9 wherein said step of selecting selects the most efficient of said alternative P-Schemas on a cost basis.

12. The method as defined in claim 11 wherein said step of selecting selects the most efficient of said alternative P-Schemas as the one having the least cost.

13. The method as defined in claim 9 wherein the step of selecting includes a) computing the efficiency of the initial P-Schema configuration with respect to a given query workload and the data statistics using a prescribed function, iteratively updating the P-Schema configuration to the most efficient configuration that can be derived from said P-Schema using a single transformation, b) evaluating each of the P-Schema configurations as to its efficiency and c) selecting the most efficient P-Schema configuration, and d) repeating steps a) through c) until the current P-Schema configuration can no longer be improved.

14. The method as defined in claim 13 wherein during each iteration of said updating step a list of said alternative P-Schema configurations is generated by applying all applicable transformations to the current alternative P-Schema configuration.

15. The method as defined in claim 13 wherein said prescribed function is based on a cost function.

16. The method as defined in claim 15 wherein said cost function is the least cost alternative P-Schema.

17. The method as defined in claim 9 wherein said step of generating an initial P-Schema includes inserting appropriate type names for prescribed elements in the XML schema so that semantics of the XML schema are preserved in the P-Schema.

18. The method as defined in claim 17 wherein said step of generating an initial P-Schema further includes gathering data statistics from the XML document and the XML Schema and inserting said statistics in said initial P-Schema during its generation.

19. The method as defined in claim 9 wherein said step of transforming includes repeatedly performing prescribed transformations on said initial P-Schema to generate said alternative P-Schemas so that any XML document valid for the initial P-Schema is valid for any of the alternative P-Schemas.
